(19) United States
(12) Patent Application Publication
(10) Pub. No.: US 2022/0158278 A1
(43) Pub. Date: May 19, 2022

(54) RECHARGEABLE BATTERY

(71) Applicant: SAMSUNG SDI CO., LTD., Yongin-si (KR)

(72) Inventors: Jinyoung MOON, Yongin-si (KR); Byoungmin CHUN, Yongin-si (KR); Jong-Ha LEE, Yongin-si (KR); Shinjung KIM, Yongin-si (KR)

(21) Appl. No.: 17/529,165

(22) Filed: Nov. 17, 2021

(30) Foreign Application Priority Data
Nov. 18, 2020 (KR) 10-2020-0154872

(51) Int. Cl. H01M 50/152; H01M 50/169; H01M 50/54

(52) U.S. Cl. CPC H01M 50/152; H01M 50/54; H01M 50/169

(57) ABSTRACT

A rechargeable battery includes: a case receiving an electrode assembly and including an opening; a cap assembly including a cap plate combined to the case and covering the opening, and a terminal plate combined to the cap plate; and a housing member covering the cap plate on an external side of the terminal plate and combined to the case, the housing member including an undercut formed toward an external surface of the case.

### CROSS-REFERENCE TO RELATED APPLICATION

This application claims priority to and the benefit of Korean Patent Application No. 10-2020-0154872, filed on Nov. 18, 2020 in the Korean Intellectual Property Office, the entire content of which is incorporated herein by reference.

### BACKGROUND

### 1. Field

Aspects of embodiments of the present invention relate to a rechargeable battery.

### 2. Description of the Related Art

Unlike a primary battery, a rechargeable battery can be repeatedly recharged and discharged. A small-capacity rechargeable battery may be used for small portable electronic devices, such as mobile phones, notebook computers, camcorders, and the like, while a large-capacity rechargeable battery may be used as a motor-driving power source for a hybrid vehicle, for example.

As typical rechargeable batteries, there are a nickel-cadmium (Ni—Cd) battery, a nickel-metal hydride (Ni-MH) battery, a lithium (Li) battery, a lithium ion (Li-ion) battery, etc. Particularly, the lithium ion rechargeable battery has an operating voltage about three times as high as that of the Ni—Cd battery or Ni-MH battery that is widely used as a power supply for electronic devices. In addition, the lithium ion rechargeable battery has been widely used because it has a high energy density per unit weight.

As demand for wearable devices, such as headphones, earphones, smartwatches, and medical devices attachable to bodies and using Bluetooth, is recently increasing, needs for very small rechargeable batteries with high energy density are increasing.

It is important for the very small rechargeable batteries to obtain electrical capacity required within a restricted size, increase efficient weight reduction, realize an efficient structure, and increase structural stability.

The matters described above as background art are provided for the purpose of increasing the understanding of the background of the present invention, and should not be taken as acknowledging that they correspond to the related art already known to those skilled in the art.

The above information disclosed in this Background section is for enhancement of understanding of the background of the invention, and, therefore, it may contain information that does not form the prior art that is already known in this country to a person of ordinary skill in the art.

### SUMMARY

According to an aspect of embodiments of the present invention, a rechargeable battery (e.g., a very small rechargeable battery) to be used together with another type of rechargeable battery in a set is provided.

According to one or more embodiments of the present invention, a rechargeable battery includes: a case receiving an electrode assembly and including an opening; a cap assembly including a cap plate combined to the case and covering the opening, and a terminal plate combined to the cap plate; and a housing member covering the cap plate on an external side of the terminal plate and combined to the case, wherein the housing member includes an undercut formed toward an external surface of the case.

The undercut may become gradually thicker in a direction toward a lower end of an internal side of the housing member from an upper end thereof.

The case may include a combined groove corresponding to the undercut on the external surface of the case.

The combined groove may become gradually deeper in a direction toward a lower end of the external surface of the case from an upper end thereof.

The undercut may be plural in a direction toward a lower end of the internal side of the housing member from an upper end thereof.

An upper undercut from among a plurality of undercuts may form a first slope on a lower side from a first maximum protruding line and may form a second slope on an upper side from the first maximum protruding line, and the first slope may be gentler than the second slope.

The case may include a plurality of combined grooves corresponding to a plurality of undercuts on the external surface of the case.

An upper combined groove from among the plurality of combined grooves may have a depth corresponding to the first slope and the second slope of the upper undercut on the external surface of the case.

A lower undercut from among the plurality of undercuts may form a third slope on a lower side from a second maximum protruding line and may form a fourth slope on an upper side from the second maximum protruding line, the third slope may be steeper than the first slope and gentler than the second slope, and the fourth slope may be steeper than the third slope and gentler than the first slope.

A lower combined groove from among the plurality of combined grooves may have a depth corresponding to the third slope and the fourth slope of the lower undercut on the external surface of the case.

The electrode assembly may include a first electrode, a second electrode, and a separator therebetween, the case may be connected to the first electrode by a first electrode tab, and the terminal plate may be connected to the second electrode by a second electrode tab.

The cap plate may be electrically connected to the case, and the cap plate and the terminal plate may be thermally fused by a thermally fused member therebetween and may be electrically insulated from each other.

The terminal plate may include: a flange portion located outside the cap plate and attached to an external surface of the cap plate so as to be electrically insulated from the external surface of the cap plate; and a protrusion end protruding to an inside from the flange portion, inserted into a terminal hole of the cap plate, and electrically connected to the second electrode tab on an internal surface.

The rechargeable battery according to an embodiment of the present invention combines the housing member in which the undercut is installed to the external side of the case, such that the rechargeable battery may be used together with other types of rechargeable batteries.

### BRIEF DESCRIPTION OF THE DRAWINGS

FIG. 1 shows a perspective view of a rechargeable battery according to an embodiment of the present invention.

FIG. 2 shows an exploded perspective view of the rechargeable battery shown in FIG. 1.

FIG. 3 shows a cross-sectional view with respect to the line III-III of FIG. 1.

FIG. 4 shows a partial cross-sectional view of a housing member according to an embodiment.

FIG. 5 shows an enlarged partial cross-sectional view in which the housing member of FIG. 4 is combined to a case.

FIG. 6 shows an enlarged partial cross-sectional view in which a housing member is combined to a case in a rechargeable battery according to an embodiment of the present invention.

FIG. 7 shows a partial cross-sectional view of a housing member according to an embodiment.

FIG. 8 shows an enlarged partial cross-sectional view in which the housing member of FIG. 7 is combined to a case.

FIG. 9 shows an enlarged partial cross-sectional view in which a housing member is combined to a case in a rechargeable battery according to an embodiment of the present invention.

DESCRIPTION OF REFERENCE SYMBOLS

| | |
|---|---|
| 10: electrode assembly | 11: first electrode |
| 12: second electrode | 13: separator |
| 14: insulating sheet | 20, 22, 23: case |
| 21: opening | 30: cap assembly |
| 31: cap plate | 33: terminal plate |
| 34: thermally fused member | 40, 70: housing member |
| 41: planar portion | 42, 72: lateral portion |
| 43, 74, 75: undercut | 51: first electrode tab |
| 52: second electrode tab | 62: insulating member |
| 100, 200, 300, 400: rechargeable battery | 101: first end (lower end side) |
| 102: second end (upper end side) | 311: terminal hole |
| 221, 231, 232: combined groove | 331: flange portion |
| 332: tab connector | 341, 411, 711: through-hole |
| 621: through-hole | 741: first slope |
| 742: second slope | 743: maximum protruding line |
| 753: third slope | 754: fourth slope |
| 756: maximum protruding line | |

### DETAILED DESCRIPTION

The present invention will be described more fully herein with reference to the accompanying drawings, in which some embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

In addition, unless explicitly described to the contrary, it is to be understood that terms such as “comprises,” “includes,” or “have” used in the present specification specify the presence of stated features, numerals, steps, operations, components, parts, or a combination thereof, but do not preclude the presence or addition of one or more other features, numerals, steps, operations, components, parts, or a combination thereof.

Also, in this specification, it is to be understood that when one component is referred to as being “connected” or “coupled” to another component, it may be connected or coupled directly to the other component or connected or coupled to another component with one or more other components intervening therebetween.

Singular forms are to include plural forms unless the context clearly indicates otherwise.

It is to be understood that, although the terms “first,” “second,” etc. may be used herein to describe various elements, these elements should not be limited by these terms. These terms are used to distinguish one element from another. For example, a first element could be termed a “second” element, and, similarly, a second element could be termed a “first” element, without departing from the scope of example embodiments of the inventive concept. The terms of a singular form may include plural forms unless the context clearly indicates otherwise.

In addition, terms such as “below,” “lower,” “above,” “upper,” and the like are used to describe the relationship of the configurations shown in the drawings. However, the terms are used as a relative concept and are described with reference to the direction indicated in the drawings.

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as having meanings consistent with the meanings in the context of the related art, and are expressly defined herein unless they are interpreted in an ideal or overly formal sense.

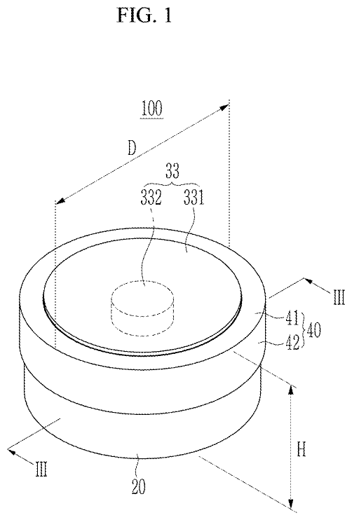

The rechargeable battery according to an embodiment of the present invention is a very small battery and may be a coin cell or a button cell. The coin cell or the button cell is a battery in a thin coin shape or a button shape, and refers to a battery of which a ratio (H/D) of a height (H) to a battery diameter (D) is equal to or less than one (refer to FIG. 1).

In an embodiment, the coin cell or the button cell may be generally cylindrical, such that a cross-section in a horizontal direction is circular, but, without being limited, may also be oval or polygonal. In this instance, the diameter is set to be a maximum distance of an exterior circumference of the housing (or the case) with reference to the horizontal direction of the battery, and the height is set to be a maximum distance (a distance to a flat uppermost side from a flat ground, or lowermost, side) with reference to a vertical direction of the battery.

However, the coin cell or the button cell is an example of embodiments of the present invention, and without being limited thereto, embodiments of the present invention may be a cylindrical battery or a pin-type battery. A case in which the rechargeable battery according to an embodiment of the present invention is a coin cell or a button cell will now be described as an example in further detail.

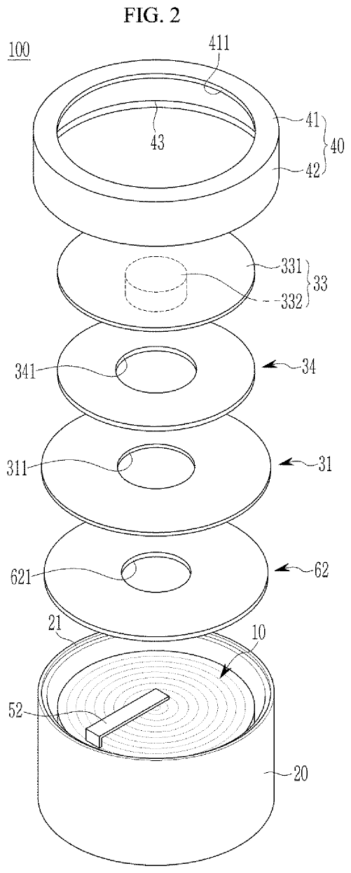

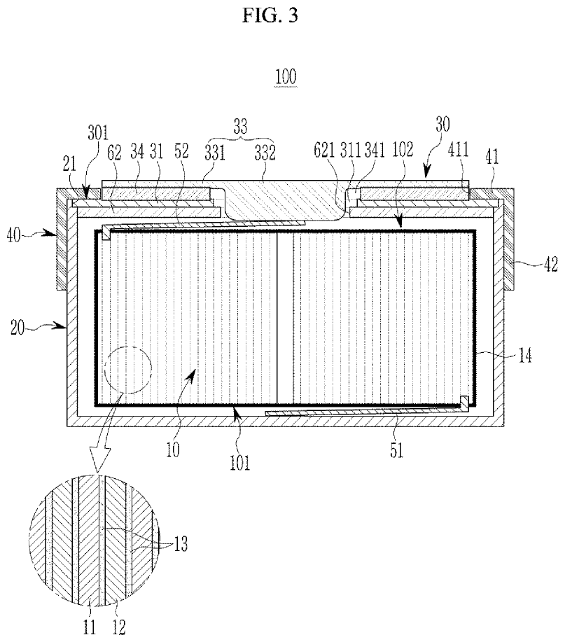

FIG. 1 shows a perspective view of a rechargeable battery according to an embodiment of the present invention; FIG. 2 shows an exploded perspective view of the rechargeable battery shown in FIG. 1; and FIG. 3 shows a cross-sectional view with respect to the line III-III of FIG. 1.

Referring to FIG. 1 to FIG. 3, a rechargeable battery 100 according to an embodiment includes an electrode assembly 10, a case 20, a cap assembly 30, and a housing member 40. The cap assembly 30 includes a cap plate 31 and a terminal plate 33 combined to each other. In an embodiment, the cap plate 31 and the terminal plate 33 are thermally fused by a thermally fused member 34 disposed therebetween.

The thermally fused member 34 functions to combine the cap plate 31 and the terminal plate 33. For example, the thermally fused member 34 may be made of an electrically insulating material, such as a polymer, and may be melted by using laser beams and may be fused on the cap plate 31 and the terminal plate 33.

In an embodiment, the terminal plate 33 is combined to the cap plate 31 by the thermally fused member 34, such that without adding an individual insulating element, a stable combined structure may be provided while efficiently insulating the terminal plate 33 from the cap plate 31.

The coin cell may be manufactured to be very small, so as to be limited in design in the viewpoint of space, such that it is desirable to simplify the configuration and the manufacturing process and obtain functionality. In an embodiment, insulation and combination between the terminal plate 33 and the cap plate 31 are performed by the thermally fused member 34.

The electrode assembly 10 includes a first electrode (e.g., a negative electrode) 11 and a second electrode (e.g., a positive electrode) 12 installed on respective sides of a separator 13 that is an electrical insulator, and may be formed by winding the first electrode 11, the separator 13, and the second electrode 12. Therefore, the electrode assembly 10 may be formed in a jelly roll type. Although not shown, the electrode assembly may also be formed in a stack type.

The electrode assembly 10 is configured to be charged and discharged with a current, and a winding axis may be arranged in parallel to a height direction (a top to bottom direction in FIG. 1 to FIG. 3) of the case 20 in the electrode assembly 10. In an embodiment, a first end (a lower end side of the electrode assembly) 101 and a second end (an upper end side of the electrode assembly) 102 of the electrode assembly 10 may be flat and may be parallel to each other. In an embodiment, the electrode assembly 10 does not include a center pin, but the electrode assembly 10 may include a center pin (not shown) at a position of the winding axis.

The case 20 faces the first end 101 of the electrode assembly 10 and receives the electrode assembly 10. In an embodiment, the electrode assembly 10 is coated with an insulating sheet 14 and is installed in the case 20. For example, the case 20 may be formed to be a cylinder for receiving the jelly roll type of electrode assembly 10, and the cap assembly 30 closes and seals an opening 21 of the cylindrical case 20.

The electrode assembly 10 includes a first electrode tab 51 connected to the first electrode 11, and a second electrode tab 52 connected to the second electrode 12, and draw the first and second electrodes 11 and 12 out to the first and second ends 101 and 102.

While the electrode assembly 10 is received in the case 20, the first electrode tab 51 is electrically connected to a bottom of the case 20, and the second electrode tab 52 is electrically connected to the terminal plate 33 of the cap assembly 30.

The cap plate 31 of the cap assembly 30 faces the second end 102 of the electrode assembly 10 and is combined to the case 20 to cover the opening 21. The terminal plate 33 is, while combined to the cap plate 31 by the thermally fused member 34, connected to the second electrode tab 52.

A case in which the first electrode 11 and the second electrode 12 are respectively a negative electrode and a positive electrode will now be described as an example, but without being limited thereto. That is, the first electrode 11 and the second electrode 12 may respectively be a positive electrode and a negative electrode.

In an embodiment, the first electrode (or the negative electrode) 11 has a long strip shape, and includes a negative coated region provided by applying a negative active material layer to a current collector of a metal film (e.g., a foil of Cu), and a negative uncoated region to which no active material is applied. The negative uncoated region may be positioned at an end in a length direction of the negative electrode.

In an embodiment, the second electrode (or the positive electrode) 12 has a long strip shape, and includes a positive coated region provided by applying a positive active material layer to a current collector of a metal film (e.g., a foil of Al), and a positive uncoated region to which no active material is applied. The positive uncoated region may be positioned at an end in a length direction of the positive electrode.

The case 20 allows the electrode assembly 10 to be inserted into the opening 21 formed in a side thereof, and has a space for receiving the electrode assembly 10 and an electrolyte solution. In an embodiment, the case 20 is formed to have a cylindrical shape with a height H that is less than a battery diameter D, and forms a circular opening 21 into which the cylindrical electrode assembly 10 corresponding to an internal space may be inserted.

Regarding the cap assembly 30, the terminal plate 33 includes a flange portion 331 and a tab connector 332. The flange portion 331 is disposed outside the cap plate 31 and is attached to an external surface of the cap plate 31 in an electrically insulated manner.

The tab connector 332 protrudes to the inside from the flange portion 331 and is inserted into a through-hole 341 of the thermally fused member 34 and a terminal hole 311 of the cap plate 31, and an internal surface of the tab connector 332 is electrically connected to the second electrode tab 52.

When assembling the rechargeable battery 100 according to an embodiment, the housing member 40 allows the rechargeable battery 100 to be used together with other types of rechargeable batteries. In an embodiment, the housing member 40 is made of an insulating material of a polymer, and may be formed of a polybutylene terephthalate (PBT), a polypropylene (PP), a polyethylene (PE), a polystyrene (PS), or an acrylonitrile butadiene styrene (ABS).

The housing member 40 covers the cap plate 31 and is combined to the case 20 outside the terminal plate 33. The housing member 40 includes an undercut (or undercut portion) 43 protruding toward an external surface of the case 20. For example, the undercut 43 may be defined by a portion on the lateral portion 42 that relatively protrudes toward the external surface of the case 20.

The housing member 40 includes a planar portion 41 and a lateral portion 42. The planar portion 41 includes a through-hole 411 corresponding to the flange portion 331 to expose the flange portion 331 of the terminal plate 33 and cover an exposed side 301 of the external surface of the cap plate 31. The lateral portion 42 extends along a lateral side of the case 20 from an outside of the planar portion 41 to cover a portion of the lateral side of the case 20 and be combined to the lateral side of the case 20. A portion combined to the housing member 40 extends in the rechargeable battery 100, such the rechargeable battery 100 may be used together with other types of rechargeable batteries.

An insulating member 62 disposed on an exterior circumference of the tab connector 332 is installed on an internal surface of the cap plate 31. The insulating member 62 may configure an electrically insulating structure between the cap plate 31 and the second electrode tab 52 and between the cap plate 31 and the electrode assembly 10.

The insulating member 62 includes a through-hole 621 corresponding to the terminal hole 311 of the cap plate 31. The through-hole 621 connects the second electrode tab 52 to the internal surface of the tab connector 332. In an embodiment, the through-hole 621 has a diameter that is less than that of the terminal hole 311 and prevents or substantially prevents the second electrode tab 52 from contacting the cap plate 31.

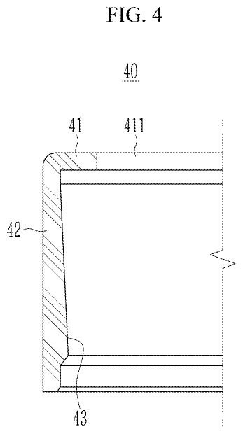

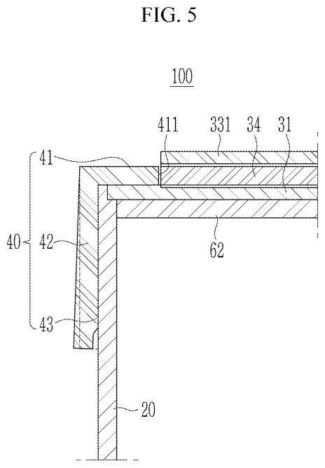

FIG. 4 shows a partial cross-sectional view of a housing member according to an embodiment; and FIG. 5 shows an enlarged partial cross-sectional view in which the housing member of FIG. 4 is combined to a case. Referring to FIG. 4 and FIG. 5, the undercut 43 increases a fastening force by which the housing member 40 is combined to the external surface of the case 20.

The undercut 43 becomes gradually thicker in a direction toward a lower end of an internal side from an upper end thereof on the lateral portion 42 of the housing member 40. That is, the lateral portion 42 is made of a cylinder with the same thickness, and the undercut 43 is made on the internal side with a variable thickness.

In an embodiment, the undercut 43 is continuously formed in a circumference direction on the internal side of the lateral portion 42; however, the undercut 43 may be intermittently formed in the circumference direction (not shown).

When the housing member 40 is combined to the case 20 on the side of the cap plate 31 of the rechargeable battery 100, the lateral portion 42 of the housing member 40 is firmly and tightly combined to the external surface of the case 20 through the undercut 43.

As shown in FIG. 5, in an embodiment, as the housing member 40 is made of a polymer material, the lateral portion 42 may be elastically operable by the undercut 43. That is, the housing member 40 may be elastically combined to the case 20 through the undercut 43.

When the undercut 43 is partially transformed, the fastening force between the housing member 40 and the case 20 may be appropriately adjusted or a mutual fastening force may be further increased.

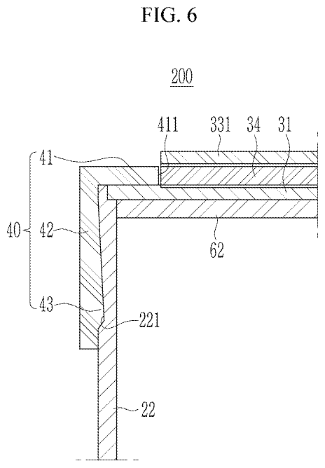

FIG. 6 shows an enlarged partial cross-sectional view in which a housing member is combined to a case in a rechargeable battery according to an embodiment of the present invention. Referring to FIG. 4 and FIG. 6, regarding a rechargeable battery 200 according to the present embodiment, a case 22 includes a combined groove 221 corresponding to the undercut 43 on the external surface.

In an embodiment, the combined groove 221 is formed to be gradually deeper in a direction toward a lower end of the external surface of the case 22 from an upper end thereof. That is, the combined groove 221 is formed corresponding to the structure of the undercut 43 that becomes gradually thicker in the direction toward the lower end of the internal side from the upper end thereof on the lateral portion 42 of the housing member 40.

Therefore, the undercut 43 may be easily combined with the combined groove 221. The combination of the undercut 43 and the combined groove 221 may further increase the fastening force of the lateral portion 42 of the housing member 40 and the case 22 compared to the above-described embodiment. When the rechargeable battery 200 is inserted into a set, a phenomenon that the housing member 40 is removed from the case 22 may be further prevented compared to the above-described embodiment. The rechargeable battery 200 according to an embodiment may be used together with other types of rechargeable batteries.

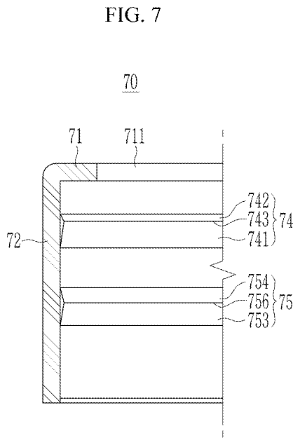

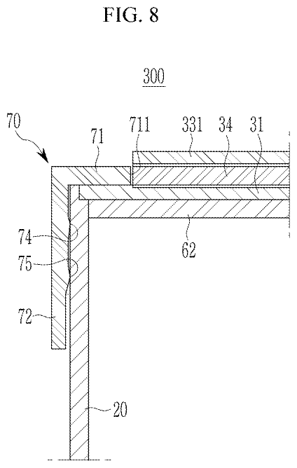

FIG. 7 shows a partial cross-sectional view of a housing member according to an embodiment; and FIG. 8 shows an enlarged partial cross-sectional view in which a housing member of FIG. 7 is combined to a case. Referring to FIG. 7 and FIG. 8, regarding a rechargeable battery 300 according to the present embodiment, undercuts 74 and 75 may be installed while going to the lower end of the internal side from the upper side thereof on a lateral portion 72 of a housing member 70.

For example, the undercuts (or undercut portions) 74 and 75 may include an upper undercut 74 and a lower undercut 75. The upper undercut 74 forms a first slope 741 toward the lower side from a maximum protruding line 743 protruding to a center of the housing member 70, and forms a second slope 742 toward the upper side from the maximum protruding line 743. In an embodiment, the first slope 741 may be formed to be gentler than the second slope 742.

The lower undercut 75 forms a third slope 753 toward the lower side from a maximum protruding line 756 protruding to the center of the housing member 70, and forms a fourth slope 754 toward the upper side from the maximum protruding line 756. In an embodiment, the maximum protruding lines 743 and 756 protrude to the center from the internal side of the lateral portion 72 with the same height on the upper and lower undercuts 74 and 75.

In an embodiment, the lowest third slope 753 is steeper than the first slope 741 and is gentler than the highest second slope 742. In an embodiment, the fourth slope 754 is steeper than the third slope 753 on the lower side and is gentler than the first slope 741 on the upper side. That is, the steepest second slope 742, the fourth slope 754, the third slope 753, and the gentlest first slope 741 may be formed in order.

Referring to FIG. 8, when the housing member 70 is combined to the case 20 on the side of the cap plate 31 of the rechargeable battery 300 through a through-hole 711, a planar portion 71 exposes and covers the flange portion 331 of the terminal plate 33, and the lateral portion 72 of the housing member 70 is firmly and closely combined to the external surface of the case 20 through the upper and lower undercuts 74 and 75. The upper and lower undercuts 74 and 75 of the lateral portion 72 may be combined to the case 20.

In an embodiment, during the combination process, the third and first slopes 753 and 741 are formed to be gentler than the fourth and second slopes 754 and 742 to facilitate the combination of the case 20 and the housing member 70. In the maintaining state after the combination, the fourth and second slopes 754 and 742 formed to be steeper than the third and first slopes 753 and 741 may more efficiently prevent separation and relative movement of the case 20 and the housing member 70.

During the combination process, the structure in which the first slope 741 is formed to be gentler than the third slope 753 prevents or substantially prevents the case 20 inserted into the third slope 753 from being inserted by the first slope 741.

In the maintaining state after the combination, the structure in which the second slope 742 is formed to be steeper than fourth slope 754 prevents or substantially prevents the inserted case 20 from being separated from and being removed from the second slope 742.

In an embodiment, the housing member 70 is made of a polymer material, and the lateral portion 72 may be elastically operable to the case 20 by the upper and lower undercuts 74 and 75. That is, the housing member 70 may be elastically combined to the case 20 through the upper and lower undercuts 74 and 75.

When the upper and lower undercuts 74 and 75 are partially transformed, the fastening force of the housing member 70 and the case 20 may be appropriately adjusted, and the mutual fastening force may be further increased.

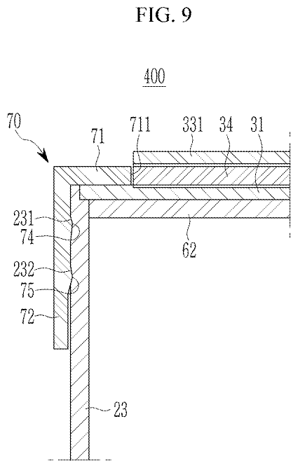

FIG. 9 shows an enlarged partial cross-sectional view in which a housing member is combined to a case in a rechargeable battery according to an embodiment of the present invention. Referring to FIG. 7 and FIG. 9, regarding a rechargeable battery 400 according to the present embodiment, a case 23 includes a plurality of combined grooves 231 and 232 corresponding to the undercuts 74 and 75 on the external surface.

The combined grooves 231 and 232 include an upper combined groove 231 and a lower combined groove 232 respectively corresponding to the upper undercut 74 and the lower undercut 75. In an embodiment, the upper combined groove 231 has a depth and a slope corresponding to the first slope 741 and the second slope 742 of the upper undercut 74 and is formed on an upper portion of the external surface of the case 23. In an embodiment, the lower combined groove 232 has a depth and a slope corresponding to the third slope 753 and the fourth slope 754 of the lower undercut 75 and is formed on a lower portion of the external surface of the case 23.

Therefore, the upper and lower undercuts 74 and 75 of the housing member 70 may be easily combined to the upper and lower combined grooves 231 and 232 of the case 23. The combination of the upper and lower undercuts 74 and 75 and the upper and lower combined grooves 231 and 232 may further increase the fastening force of the lateral portion 72 of the housing member 70 and the case 23 compared to the rechargeable battery 300. When the rechargeable battery 400 is inserted into a set, a phenomenon that the housing member 70 is removed from the case 23 may be further prevented compared to the rechargeable battery 300.

While the present invention has been described in connection with what are presently considered to be some practical embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery comprising:
a case receiving an electrode assembly and comprising an opening;
a cap assembly comprising a cap plate combined to the case and covering the opening, and a terminal plate combined to the cap plate; and
a housing member covering the cap plate on an external side of the terminal plate and combined to the case,
wherein the housing member comprises an undercut formed toward an external surface of the case.

2. The rechargeable battery of claim 1, wherein the undercut becomes gradually thicker in a direction toward a lower end of an internal side of the housing member from an upper end thereof.

3. The rechargeable battery of claim 1, wherein the case comprises a combined groove corresponding to the undercut on the external surface of the case.

4. The rechargeable battery of claim 3, wherein the combined groove becomes gradually deeper in a direction toward a lower end of the external surface of the case from an upper end thereof.

5. The rechargeable battery of claim 1, wherein the undercut is plural in a direction toward a lower end of an internal side of the housing member from an upper end thereof.

6. The rechargeable battery of claim 1, wherein an upper undercut from among a plurality of undercuts forms a first slope on a lower side from a first maximum protruding line and forms a second slope on an upper side from the first maximum protruding line, and the first slope is gentler than the second slope.

7. The rechargeable battery of claim 6, wherein the case comprises a plurality of combined grooves corresponding to the plurality of undercuts on the external surface of the case.

8. The rechargeable battery of claim 7, wherein an upper combined groove from among the plurality of combined grooves has a depth corresponding to the first slope and the second slope of the upper undercut on the external surface of the case.

9. The rechargeable battery of claim 8, wherein
a lower undercut from among the plurality of undercuts has a third slope on a lower side from a second maximum protruding line and has a fourth slope on an upper side from the second maximum protruding line,
the third slope is steeper than the first slope and gentler than the second slope, and
the fourth slope is steeper than the third slope and gentler than the first slope.

10. The rechargeable battery of claim 9, wherein a lower combined groove from among the plurality of combined grooves has a depth corresponding to the third slope and the fourth slope of the lower undercut on the external surface of the case.

11. The rechargeable battery of claim 1, wherein
the electrode assembly comprises a first electrode, a second electrode, and a separator therebetween,
the case is connected to the first electrode by a first electrode tab, and
the terminal plate is connected to the second electrode by a second electrode tab.

12. The rechargeable battery of claim 11, wherein
the cap plate is electrically connected to the case, and
the cap plate and the terminal plate are electrically insulated from each other and are thermally fused by a thermally fused member therebetween.

13. The rechargeable battery of claim 11, wherein the terminal plate comprises:
a flange portion located outside the cap plate and attached to an external surface of the cap plate so as to be electrically insulated from the external surface of the cap plate; and
a protrusion end protruding to an inside from the flange portion, inserted into a terminal hole of the cap plate, and electrically connected to the second electrode tab on an internal surface.
